(19) United States
(12) Patent Application Publication
(10) Pub. No.: US 2002/0039115 A1
(43) Pub. Date: Apr. 4, 2002

(54) Communication device, service center and service method and image reading software

(76) Inventor: Iwao Kawashima, Tokyo (JP)

Correspondence Address: BIRCH STEWART KOLASCH & BIRCH, PO BOX 747, FALLS CHURCH, VA, 22040-0747, US

(21) Appl. No.: 09/968,485

(22) Filed: Oct. 2, 2001

(30) Foreign Application Priority Data
Oct. 2, 2000 (JP) 2000-301975

(51) Int. Cl. G06F 3/00; G06F 13/00

(52) U.S. Cl. 345/810

(57) ABSTRACT

The communication device, the service center and the service method and the image reading software enable the user to easily select an image subjected to a service and a desired service and simultaneously transmit them to a service center, and the service center receiving these information can rapidly perform the service desired by the user. A communication device (a personal computer) includes: a recording device which records images; a display device (display screen) which displays the images recorded on the recording device for the user and simultaneously displays a service menu indicating a plurality of services provided by the service center; a selecting device through which the user selects a desired image for which the user desires a service from among the displayed images, and selects a desired service from among the service menu; and a communicating device which simultaneously transmits information showing the selected image and service through a network.

### BACKGROUND OF THE INVENTION

1. Field of the Invention

The present invention relates to a communication device, a service center and a service method and an image reading software, and more particularly to a communication device, a service center and a service method and an image reading software for performing a transmission of images or audio information or a conveyance of a printed matter through a communication network.

2. Description of the Related Art

When a user takes picture images by an electronic camera and sends them to a print service or the like, the user is ordinarily accustomed to record the taken images on an auxiliary recording device of a personal computer, then form a recording medium on which image files and order information files are recorded to bring the recording medium thus formed to a shop of a print service for requesting it to be printed.

Further, with the recent spread of an environment in which a personal computer is connected to the internet to transmit and receive information, various kinds of image service sites have been started up on the internet. When these image service sites are utilized, a communication is customarily connected to a print service site of the internet or the like from the personal computer to receive a home page in which the contents of the service are recorded. Then, a lot of required information such as the delivery position of the prints of the picture images and so on is habitually inputted, then, an image file is selected and a selected image is transmitted to receive the print service.

However, it has been hitherto necessary to receive the display information of the home page of a service site through the internet, display the home page on a personal computer of a user side and designate and transmit images recorded on the recording medium of the personal computer of the user side on the displayed home page.

Further, it has been inconveniently difficult to select, designate and transmit a plurality of arbitrary image and audio files recorded on the personal computer of the user side. Still further, when the user selects a plurality of images or moving image data while the user sees thumb nail images, the user needs to initially send the thumb nail images to the displayed home page, and then display the thumb nail images in the user side so as to select desired images, so that it customarily takes much time to display the desired images. Therefore, the above described system has undesirably caused an inconvenience such as an inferior maneuverability.

### SUMMARY OF THE INVENTION

The present invention is achieved by taking these problems into account, and it is an object of the present invention to provide a communication device, a service center and a service method and an image reading software by which a user can easily select a static image or a moving image subjected to a service and a desired service by using image reading software and simultaneously transmit them to a server or a service center, and the server or the service center receiving these information can rapidly perform the service desired by the user.

For attaining the above described object, the present invention is directed to a communication device, comprising: a recording device which records images; a display device which displays the images recorded on the recording device for a user and simultaneously displays a service menu indicating a plurality of services provided by a service center; a selecting device through which the user selects a desired image for which the user desires a service from among the displayed images, and selects a desired service from the service menu; and a communicating device which simultaneously transmits information showing the desired image and the desired service through a network.

According to the present invention, the user can easily select the image receiving a service and the desired service and rapidly transmit them.

Further, for attaining the above described object, the present invention is directed to a service center, comprising: a recording device on which a service menu showing a plurality of services provided for a user is recorded; a communicating device which transmits the service menu recorded on the recording device to a user side and simultaneously receives information showing an image and a service from the user side; and a device which provides a service corresponding to the received information showing the image and the service.

According to the present invention, the service desired by the user can be quickly carried out.

Still further, for attaining the above described object, the present invention is directed to an image reading software having an image reading function for displaying, on a display device of a personal computer, images recorded on at least one of a recording device incorporated in at least one of the personal computer, an external recording device and an electronic camera connected to the personal computer, the software comprising: a transmit image selecting function which selects at least one image from among the images displayed on the display device by the image reading function in accordance with an instruction and input of a pointing device in order to transmit the image to a desired home page on the internet; a home page selecting function which displays buttons showing a plurality of home pages as destinations to which the at least one image is transmitted on the display device together with the at least one image and selects a desired home page in accordance with the instruction and input of the pointing device; and a function which automatically transmits the at least one image and information attached to the at least one image to the selected home page when the at least one image is selected and the desired home page as the destination to which the at least one image is transmitted is selected.

According to the present invention, the user can readily select the image receiving a service and the desired home page and transmit information of them to a desired server.

### BRIEF DESCRIPTION OF THE DRAWINGS

The nature of this invention, as well as other objects and advantages thereof, will be explained in the following with reference to the accompanying drawings, in which like reference characters designate the same or similar parts throughout the figures and wherein:

FIG. 1 shows a configuration of a service system and a connecting form employed when a user transmits an image to a server;

FIG. 2 shows the form of a flow of information transmitted and received between an electronic camera and a service center;

FIG. 3 is a diagram showing the display screen of an image viewer displayed on a display device of a personal computer;

FIG. 4 is a block diagram of a service system for transmitting the using information and image information of a service inputted by the user;

FIG. 5 shows another example to which the service system of the present invention is applied;

FIG. 6 is a flowchart concerning the start of the image viewer and the presentation of a menu provided by a “FutureGate”; and

FIG. 7 is a flowchart concerning the execution of the “FutureGate” menu of the image viewer.

### DETAILED DESCRIPTION OF THE PREFERRED EMBODIMENTS

Now, preferred embodiments of a communication device, a service center and a service method and an image reading software according to the present invention will be described below in detail by referring to the accompanying drawings.

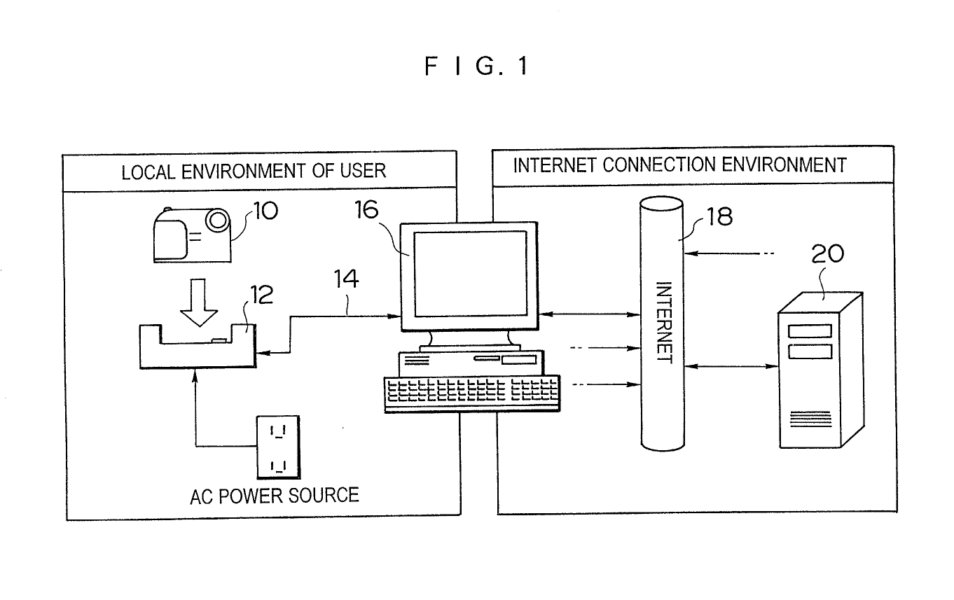

FIG. 1 is a diagram showing a configuration and a connecting form of a service system used when a user transmits an image to a server.

In FIG. 1, the service system comprises an electronic camera 10 which can record user setting information set by a user and an image picked up or photographed by the user and transmit these recorded information to other communication device, a cradle 12 as a relay device connected through a communication to the communicating device of the electronic camera 10 and capable of supplying power to the electronic camera 10, a personal computer 16 as a communication device which can transmits information such as an image to and receive information from the cradle 12 through a communicating device 14 such as a USB (a communicating device based on the communication standard of a Universal Serial Bus) and can transmits information such as an image to or receive information from a server or a service center through a network and a service center 20 such as a server which can transmits and receive information such as an image or sound, etc. through a communication network such as an internet 18.

Since the service system is constituted as described above, the personal computer 16 can transmit and receive information such as a service menu or an image between the service center 20 and itself. The electronic camera 10 is provided with at least an image pick-up device which picks up or photographs an object to be photographed, a recording device which records images and sounds and a communicating device which transmits and receive information between other communication device and the communicating device.

The personal computer 16 (the communication device) is provided with a communicating device which transmits information to and receives information from the electronic camera 10, a communicating device which can transmit information to and receive information from the communication network such as the internet 18, a display device which displays the identifying information of each image and sound to the user and displays information such as the service menus provided by the respective service centers 20, 20, . . . , a selecting device (including a transmit image selecting function) which selects an image or a sound for which the user desires a service from among the identifying information of the displayed images or sounds, a selecting device (including a function of a home page selecting device) which selects a service or a home page desired by the user from among the information such as the displayed service menus, and a recording device on which various kinds of execution programs or the information of images and sounds are recorded. In the personal computer 16, a software is adapted to function, which has an image reading function for displaying images recorded on the recording device incorporated in the personal computer, or an external recording device or the electronic camera connected to the personal computer on the display device of the personal computer.

The server such as the service center 20 or the like is provided with a communicating device which transmits various kinds of information to and receive information from the communication network such as the internet 18, a recording device on which user setting information, using information, service menu information provided for a user, and information including a password, a payment method for a using charge paid by the user of the electronic camera 10 are recorded, and a determining device which determines a display priority of a plurality of services provided for the user on the basis of the service using information of the user.

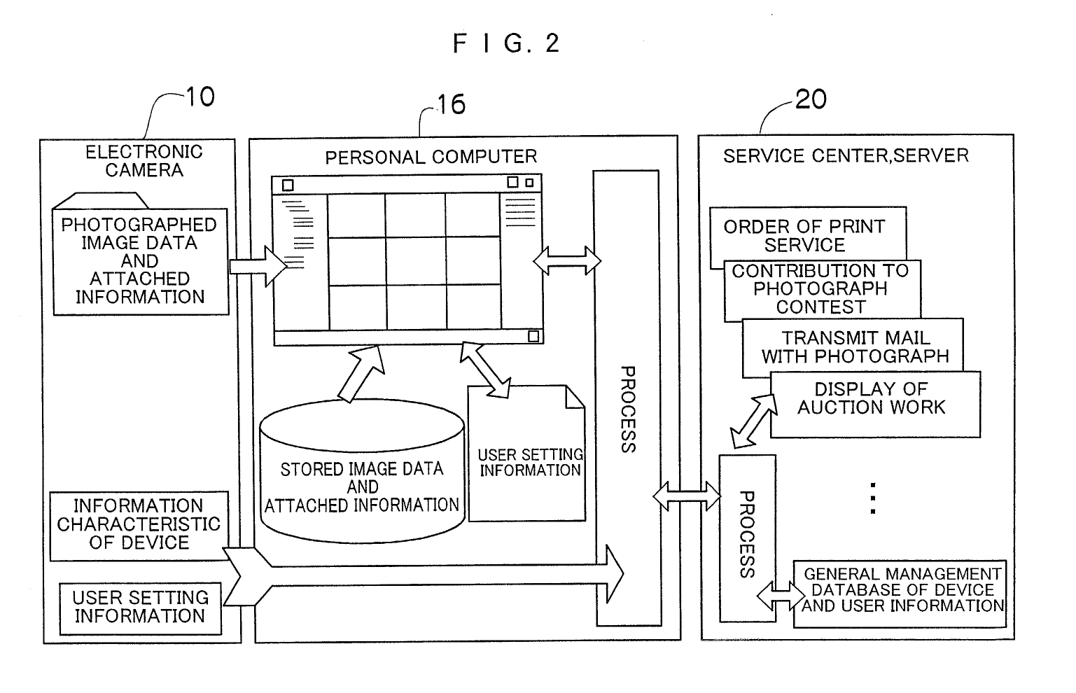

FIG. 2 shows a manner of a flow of information transmitted and received between the electronic camera and the service center.

Referring to FIG. 2, picked-up or photographed image data and accessory information thereof, identifying information peculiar to the electronic camera 10 and the user setting information such as an address or a credit card number which may be customarily utilized by the user can be transmitted to the personal computer 16 through the communicating device 14 from the electronic camera 10.

The electronic camera 10 is inserted into the cradle 12 so that the personal computer 16 side automatically detects the connection of the electronic camera 10 thereto through the communicating device of the USB or the like (by using a Plug & Play function) to automatically start an image viewer serving as an application software for displaying the list of the images in the electronic camera 10. For instance, the function for automatically detecting the connection of the electronic camera 10 serves to incorporate a device driver for automatically detecting the connection of the electronic camera 10 upon start or after start of the system program of the personal computer 16 and to monitor the Plug & Play event of a communication system. When the device driver recognizes the connection of the electronic camera 10, the necessary processing programs of the image viewer or the like are started in accordance with the processing mode of the electronic camera 10.

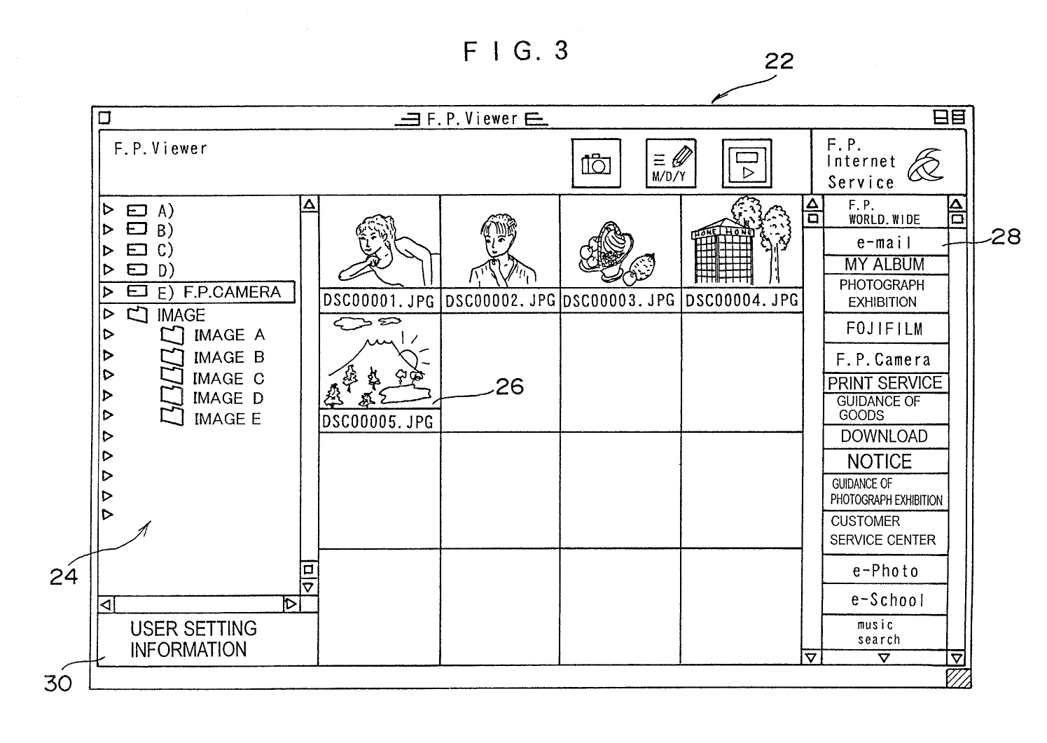

FIG. 3 shows a display screen of the image viewer (an image reading software) displayed on the display device of the personal computer.

In the display screen 22 (the display device of the personal computer 16) displayed by the image viewer, are simultaneously displayed a file list 24 on which, for instance, the identifying information of the photographed or picked up image data and the attached information recorded on the recording medium of the electronic camera 10 and the identifying information of the folder names and the file names of stored image data and the attached information recorded in the data base (the recording device) of the personal computer 16 are described, various kinds of instruction buttons 28 (the home page selecting devices) for instructing the display of a list of the reduced images (identifying information by thumb nail images) 26 of the respective images recorded in the folder instructed to be read or inspected by the user, the display of a menu of various kinds of services and a connection to the service center 20 which performs a variety of services, a user setting information button 30 by which the user setting information inputted and set by the user can be recognized or corrected.

When the information recorded on the folder which is instructed to be read or inspected is composed only of audio information, only a service menu of the service center 20 such as a music site related to musical sound is displayed. Further, when the recorded information is composed only of image information or when the electronic camera 10 is not provided with an audio reproducing function(in that case, a service menu is usually selected on the basis of the information of the electronic camera 10 recorded on the server of the service center 20 in association with the received identifying information peculiar to the camera, transmitted to the personal computer 16 and displayed), only the service menu of the service center 20 related to the image is displayed. Unnecessary information is not displayed to decrease the number of choices of the user for an easy use.

The user employs an input device (various kinds of selecting devices and instruction and input devices) representative of a pointing device or a keyboard such as a mouse to select one to a plurality of desired images from the list of the displayed file names or the reduced images 26 and simply presses the instruction buttons 28, 28, . . . for instructing the connection or transmission to various kinds of service centers 20, (for instance, a service selecting device and a home page instructing and inputting device such as a print service button provided in accordance with a price, a quality and an appointed date, a photograph CD forming service button, a photograph exhibition button, a photograph contest contribution button, an auction site transmitting button, a display button for a portable telephone, etc.) so that the print service information of the desired image can be transmitted and image files or audio file for the photograph CD forming service, the photograph exhibition service on the internet and the contribution to the photograph contest can be uploaded.

The images and sounds selected as described above and the information on a service whose execution is desired in the service center 20 are linked in the application program of the image viewer and transmitted to the service center 20 (home page) instructed by the instruction button 28. When the personal computer 16 is connected to a provider of the internet or the like through the public line of a telephone, if the image and the sound and the service center 20 are selected and instructed by the user, the personal computer 16 will perform a dialing-up operation to start a communication with the provider of the internet or the like. Then, information related to the IP address or the domain name of the service center 20 as a destination of connection, information related to an IP address or a domain name allocated to the personal computer 16, desired service information, the data of selected images and sounds and the identifying information of the user are transmitted at the same time.

The service center 20 simultaneously receives the IP address or the domain name of the personal computer 16 as a transmitter, the service information and the image and audio data and the identifying information of the user and directly transmits to the personal computer 16 side the received information on an operating screen (including the information of optimum service menu suitable for the user, the information of optimum service menu recorded in association with the using information of the service center 20 or a server site up to now and the information of the service menu of a home page located in a position deeper in hierarchy than the top page of the service center 20).

Then, when the identifying information related to the user and a password inputted lately by the user are received, the password previously recorded in the recording device in association with the user is read out and a collating device collates the read password with the password inputted lately by the user. As a result of the collation, when it is decided that the password previously recorded in the recording device is equal to the password lately inputted by the user, the provision of services such as the transmission of the image or sound instructed from the user side or the process of the transportation of a printed matter instructed from the user side is permitted and performed. As the information of the destination of transportation of goods, is employed the information of an address as the destination of transportation included in the user setting information previously recorded in the recording device in association with the received identifying information of the user. Further, when the payment methods of the using fees of various kinds of services provided by the service center 20 are included in the user setting information (when they are recorded in a payment information recording device), a payment information selecting device selects the payment method of the using fee described in the user setting information. Thus, the fee receiving device of the service center 20 receives the using fee on the basis of the collated result of the payment method of the using fee and the password.

The information on the operating screen that the service center 20 transmits to the personal computer 16 to notify may have a form of a defaulted general purpose operating screen, or the contents of the operating screen may be changed on the basis of the frequency in use of the user or the using information such as the using history.

Further, the using information related to the frequency in use of the service center 20 by the user or the contents of use is sequentially recorded in the recording device. When the identifying information of the user is received from the user side, information useful for individual users may be selected from among a plurality of kinds of using information of the service centers 20 recorded in the recording device or the latest customary operating screen may be notified to the users on the basis of the using information of this time and the using information related to the frequency in use or the contents of use stored in the recording device. Further, the display priority may be reshuffled so that the information of the service center 20 high in its frequency in use may be precedently displayed, or the service center 20 high in its frequency in use may be precedently displayed at a position where the user can easily choose.

Since the service site has been hitherto searched for to open the home page of the service site and select an image after the user designates a desired service, a long connecting time for communication has been required and a selection order has been inconveniently unreasonable and an operability has been undesirably deteriorated. However, according to the present invention, since the user initially selects the desired image on the image viewer and the desired service at the same time from among the displayed service menu, the image and the desired service can be reasonably and rapidly selected. Further, the communication with the internet 18 can be started after the image or the desired service are selected, so that a time required for the communication can be shortened.

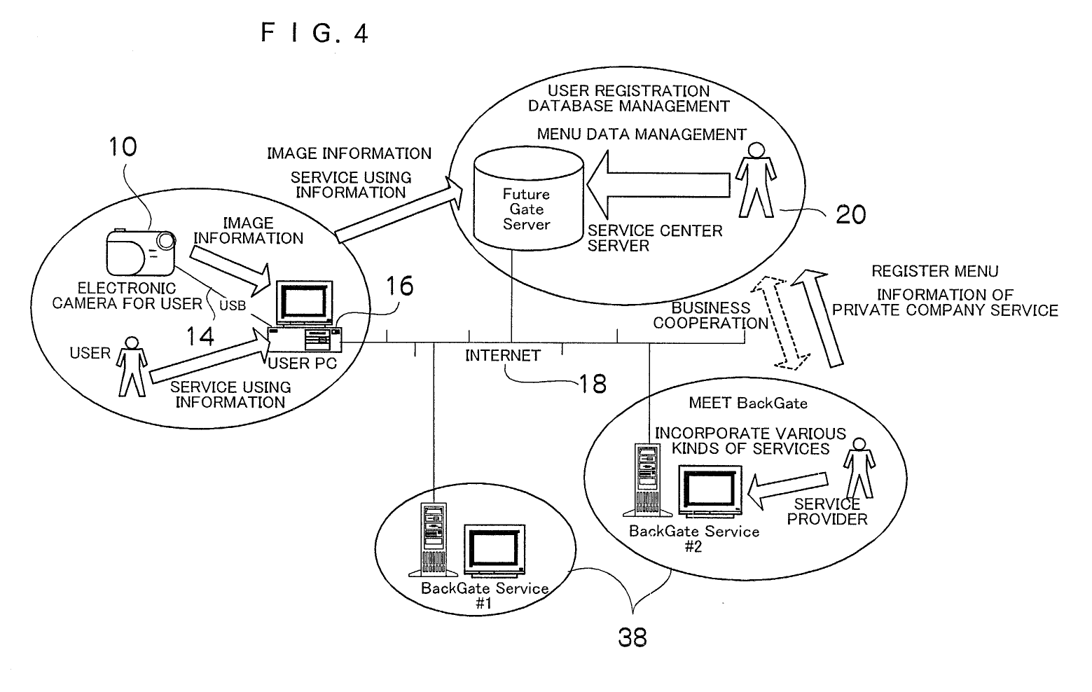

FIG. 4 shows the configuration of a service system which transmits the using information of services and image information inputted by the user.

As shown in FIG. 4, image information is transmitted to the personal computer 16 from the electronic camera 10 owned by the user. Further, the user selects and inputs the using or available information of services relative to the personal computer 16. The image information and the service available information are simultaneously transmitted to the service center 20 of a “FutureGate Server” through the communication network such as the internet 18 from the personal computer 16. In the “FutureGate Server”, the service menu information related to various kinds of services and the information of a private company are received from a service provider and the service available information, the image information and the menu data are recorded so as to be associated mutually.

Further, the service provider performs an operation for incorporating a variety of services meeting a BackGate relative to the service center 38 of each “BackGate Service”. The service center 38 of each “BackGate Service” carries out a transmitting process of prints or a transmitting process of images or sounds to the user.

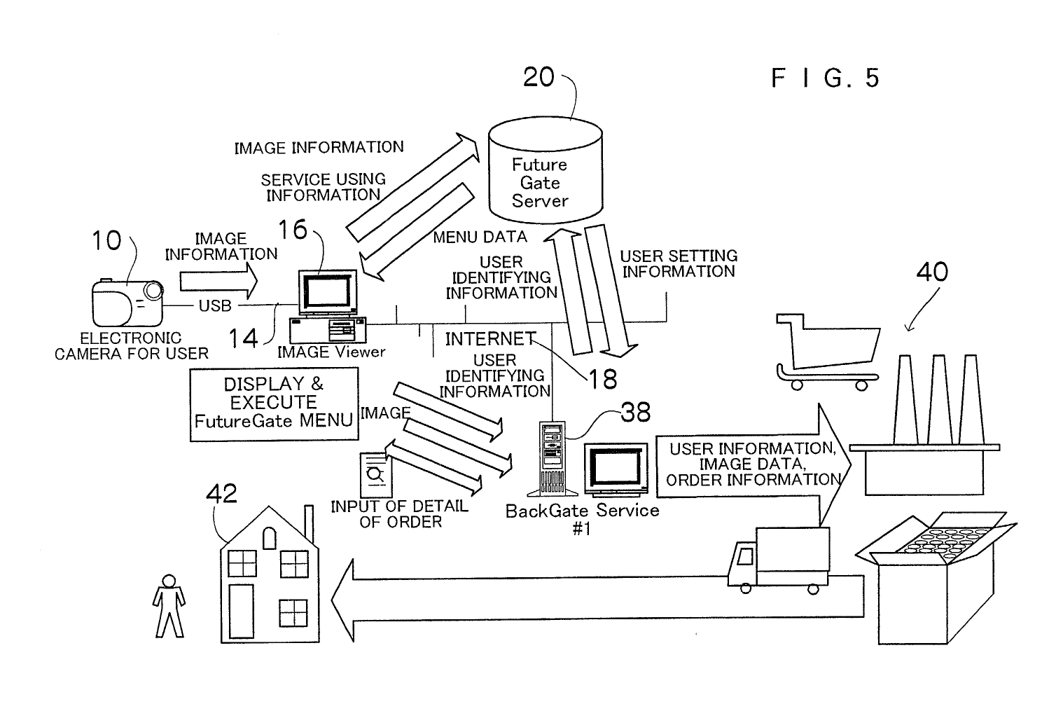

FIG. 5 shows another example to which the service system of the present invention is applied.

Referring to FIG. 5, when the electronic camera 10 of the user is connected to the communicating device 14, the program of the image viewer automatically starts on the personal computer 16 and the connection with the communication network such as the internet 18 starts. Image information and service information are simultaneously transmitted to the “FutureGate Server” through the internet 18 from the personal computer 16. The “FutureGate Server” selects proper service menu information based on the received image information and the service information and transmits the selected information to the personal computer 16.

When information such as the received service menu is displayed on the image viewer of the personal computer 16, the user selects desired images or sounds and selects a desired service and instructs them to be transmitted. In such a manner, the selected image information and the detailed order information of the service and the identifying information of the user are transmitted to the service center 38 of the “BackGate Service” through the internet 18. In the service center 38 of the “BackGate Service”, the received identifying information of the user is transmitted to the service center 20 of the “FutureGate Server” to request the user setting information to be transmitted. In the FutureGate Server”, the user setting information such as the address of the user to which articles are transported is transmitted to the “BackGate Service”.

The “BackGate Service” which receives the user setting information transmits the received user setting information and, for instance, the data of images to be printed and the detailed information of a print service to a service center 40 or the like for transportation. The service center 40 for transportation which receives the above described information carries out a printing process of goods in accordance with the detailed order information and transmits the printed goods to the destination of transportation (for example, a user's house 42) described in the user setting information.

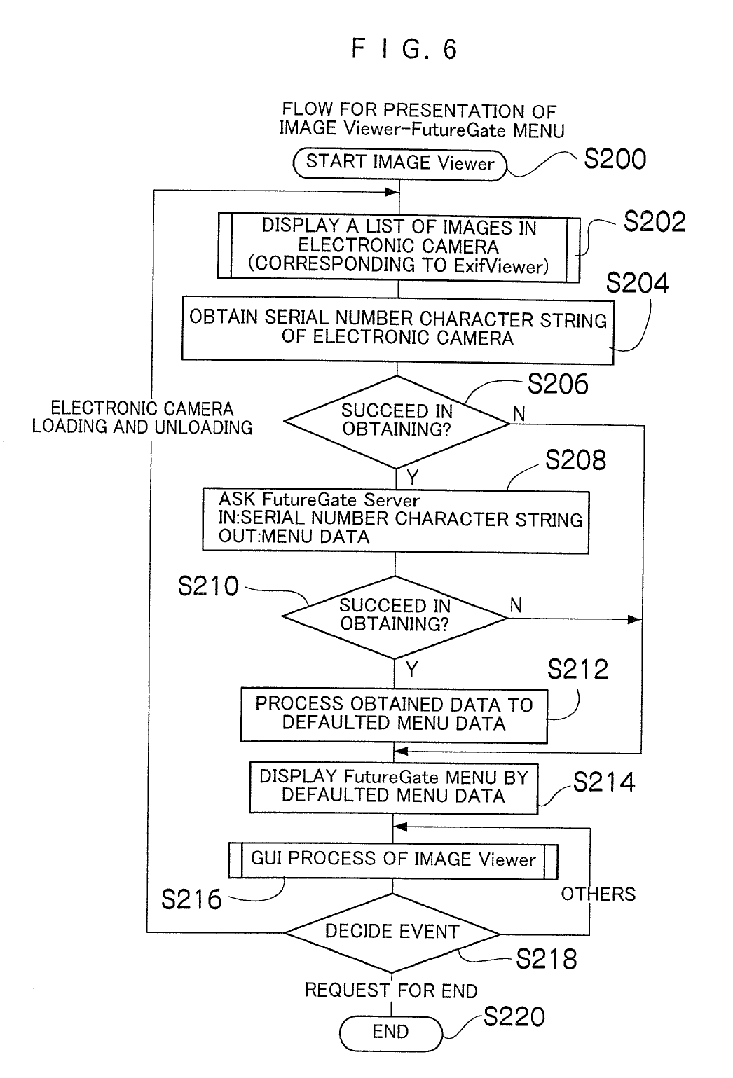

FIG. 6 shows a flowchart concerning the start of the image viewer and the presentation of the menu provided by the “FutureGate”.

When the electronic camera 10 is connected to the cradle 12, the image viewer (the image reading software) can automatically start. Further, the user operates the personal computer 16 when the electronic camera 10 is not connected to the personal computer 16 so that the image viewer can be started.

When the image viewer is started in step S200 in accordance with “start image viewer” (abbreviated like S200, hereinafter), the processing program of the image viewer advances to S202 in accordance with “display the list of images in electronic camera (corresponding to ExitViewer)” to start a communication with the electronic camera 10 through the communicating device 14, read out images recorded on the recording medium of the electronic camera 10 and display the list of the images or the reduced images on the display screen 22.

In next S204, in accordance with “obtain the serial number character string of electronic camera”, the character string of the serial number of the electronic camera 10 which is one example of the identifying information peculiar to the electronic camera 10 is received through the communicating device 14. For example, when the electronic camera 10 and the personal computer 16 perform the receiving and transmitting processes of information through the communicating device 14 of the USB, the character string of the serial number characteristic of the electronic camera 10 can be received from device descriptive information upon Plug & Play.

In accordance with “succeed in obtaining?” in next S206, it is decided whether or not the serial number of the electronic camera 10 is obtained. If the serial number of the electronic camera 10 is obtained in the S206, the processing program will advance to S208 of “ask FutureGate Server IN: serial number character string; OUT: menu data”. If the serial number cannot be obtained, the procedure will branch to S214. In the S208, the personal computer 16 transmits the serial number as the identifying information characteristic of the electronic camera 10 to the “FutureGate Server”. The “FutureGate Server” selects proper service menu data corresponding to camera information recorded in the library of the data base (recording device) of the server in association with the identifying information peculiar to the electronic camera 10 and transmits the selected service menu data to the personal computer 16. At this time, in a plurality of menu information recorded in the data base of the “FutureGate Server”, the display priority of the menu information may be dynamically determined and constructed and transmitted to the personal computer 16.

In accordance with “succeed in obtaining?” in S210, the “FutureGate Server” decides whether or not the service menu data is obtained. If the service menu data is obtained, the processing program advances to S212 of “process the obtained data to defaulted menu data” to perform a process for recording the obtained service menu data as defaulted menu data to move to the S214 of “display FutureGate menu by the defaulted menu data”. Further, when the service menu data cannot be obtained in the S210, the processing program is directly branched to the S214.

In the S214, a process for displaying the defaulted menu recorded in the S212 is carried out. Accordingly, immediately after the image viewer is installed, an installed initial menu is adapted to be displayed. Further, when a communication with the “FutureGate Server” is previously carried out, a cached menu is displayed.

In accordance with “GUI process of image viewer” in next S216, the image viewer displays the identifying information of the images or sounds recorded in the recording medium of the electronic camera 10 on the display screen 22 and displays the latest service menu. In the service menu, the latest service menu is not only simply displayed, as described above, but also the “FutureGate Server” employs the identifying information characteristic of the electronic camera 10 to perform a control to receive and display the menu of a download service of music only when the electronic camera 10 has a music reproducing function. Further, the “FutureGate Server” employs the identifying information peculiar to the electronic camera 10 to perform a control (the function of the determining device for determining the display priority) to identify the user and reshuffle the display priority of menu items for each user even when the types of machines are the same.

The user selects desired images and sounds and a desired service by using a GUI (for instance, a drag & drop function of Graphic•User•Interface) on the basis of the identifying information of the displayed images or sounds and the information such as the service menus in the S216 and the selected images and sounds and the information concerning the service are linked together in the image viewer and transmitted together.

In accordance with “decide event” in next S218, the Plug & Play event in which the electronic camera 10 is detachably attached to the cradle 12 is monitored and a request for completing the program of the image viewer by the user is monitored. In accordance with the decision of the S218, when it is decided that the electronic camera 10 is attached to or detached from the cradle 12, the processing program branches to the S202. If it is decided that there is a request for completing the program of the image viewer from the user, the processing program advances to S220 of “end” to finish the program of the image viewer. In other case, a process for returning to the S216 is carried out.

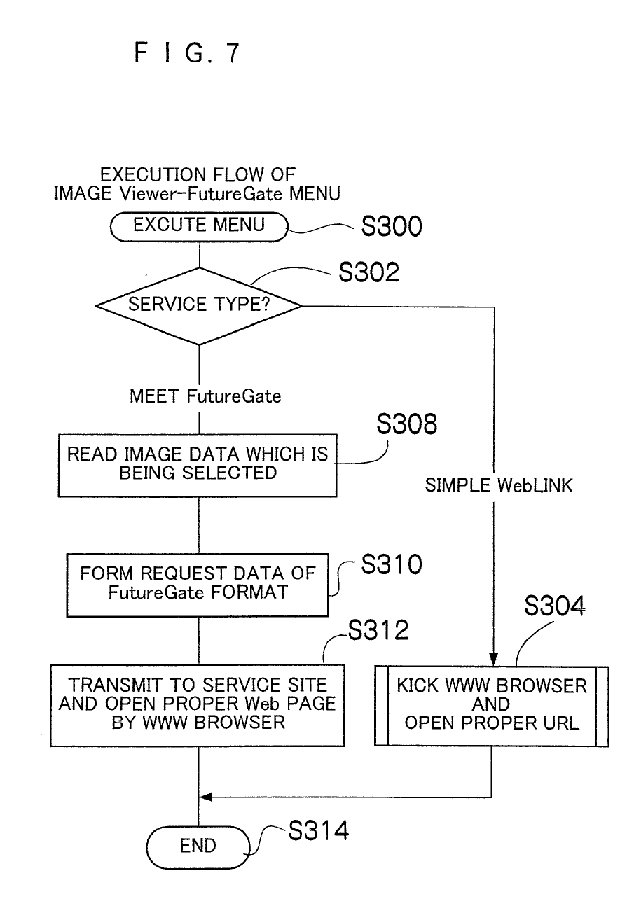

FIG. 7 shows a flowchart concerning the execution of the “FutureGate” menu of the image viewer.

The state of the “FutureGate” menu is managed. When an image in the display of a list of the image viewer is clicked to be selected, and when it is not selected, the valid/invalid states of the individual buttons of the “FutureGate” menu are changed. At this time, when the button set to a valid sate is pressed, the “FutureGate” menu is displayed.

Referring to FIG. 7, when the menu is instructed to be executed in accordance with “execute menu” in S300, the processing program advances to a decision of “service type” in S302. In the S302, it is decided whether the service type meets the “FutureGate” or a “simple Web Link”. If the service type meets the “simple Web Link”, the processing program advances to “kick a WWW browser and open a proper URL” in S304 and the program of the web browser is started to transmit the relevant URL information and display the home page of a desired service site.

Further, when the service type meets the “FutureGate” in the S302, the processing program advances to “read image data which is being selected” in S308. In the S308, image and audio data selected by the user from among the display of the list of identified and displayed images and sounds are received from the electronic camera 10 or read from the recording device of the personal computer 16. In accordance with “create request data of FutureGate format” in next S310, the information including the information of a service selected by the user from among the service information displayed in the menu, the image and audio information and the identifying information of the user is formed as the request data of a common format for the “FutureGate Server” and the request data is simultaneously transmitted in accordance with “transmit to a service site and open a relevant Web page in WWW browser” in next S312. The FutureGate Server” which simultaneously receives the request data of the common format selects the user setting information recorded in the database in association with the identifying information of the user.

Further, since the image viewer activates the Web browser, the user can read or inspect the home page of a desired service site. Usually, in order to ask a service in the service site, it is necessary to select and upload user information, images and sounds as objects successively from the top page on the GUI of the WWW browser. However, the “FutureGate Server” receives the data of a format meeting the “FutureGate Server”, so that a procedure on the upload can be greatly saved and an operability can be improved. Therefore, the user seems to directly jump in a short-cut manner into the WEB page generally appearing after the procedure to the upload of the images and sounds is performed, which has been hitherto required.

When the user instructs the completion of reading the Web, the processing program advances to “end” in next S314.

In the above described embodiment, although the communication device is described as the general purpose personal computer 16, it is to be understood that the present invention is not limited thereto, and the present invention maybe applied to a portable telephone including display device, recording device, communicating device and input device, an electronic camera and a kiosk type machine installed in a shop so that the object of the present invention can be achieved.

As described above, according to the present invention, since the communication device comprises a recording device which records images; a display device which displays the images recorded on the recording device for a user and simultaneously displays a service menu indicating a plurality of services provided by a service center; a selecting device which selects an image for which the user desires a service from among the displayed images and a service desired by the user and a communicating device which simultaneously transmits information showing the selected image and the selected service through a network, the user can easily select the image receiving the service and the desired service and rapidly transmit them.

Further, according to the present invention, since the service center comprises a recording device on which a service menu provided for a user is recorded; a communicating device which transmits the service menu to a user side and simultaneously receives information showing an image and a service from the user side; and a device which provides a service corresponding to the received information showing the image and service, the service desired by the user can be rapidly carried out.

Still further, according to the present invention, since the image reading software comprises a transmit image selecting function which selects one to a plurality of images from among the images displayed on the display device by the image reading function in accordance with an instruction and input of a pointing device in order to transmit one to a plurality of images to a desired home page on the internet; a home page selecting function which displays buttons showing a plurality of home pages as destinations to which the images are transmitted on the display device together with the images and selects a desired home page in accordance with the instruction and input of the pointing device; and a function which automatically transmits one to a plurality of selected images and information attached to the images to the selected home page when one to a plurality of images are selected and the desired home page as the destination to which the selected images are transmitted is selected, the user can readily select the images receiving the service and the desired home page and quickly transmit the information to the desired server.

It should be understood, however, that there is no intention to limit the invention to the specific forms disclosed, but on the contrary, the invention is to cover all modifications, alternate constructions and equivalents falling within the spirit and scope of the invention as expressed in the appended claims.

What is claimed is:

1. A communication device, comprising:
a recording device which records images;
a display device which displays the images recorded on the recording device for a user and simultaneously displays a service menu indicating a plurality of services provided by a service center;
a selecting device through which the user selects a desired image for which the user desires a service from among the displayed images, and selects a desired service from the service menu; and
a communicating device which simultaneously transmits information showing the desired image and the desired service through a network.

2. A communication device, comprising:
a first communicating device which receives images from other communication device;
a display device which displays the images received from other communication device for a user and simultaneously displays a service menu indicating a plurality of services provided by a service center;
a selecting device through which the user selects a desired image for which the user desires a service from among the displayed images, and selects a desired service from the service menu; and
a second communicating device which simultaneously transmits information showing the desired image and the desired service through a network.

3. A service center, comprising:
a recording device on which a service menu showing a plurality of services provided for a user is recorded;
a communicating device which transmits the service menu recorded on the recording device to a user side and simultaneously receives information showing an image and a service from the user side; and
a device which provides a service corresponding to the received information showing the image and the service.

4. The service center according to claim 3, wherein the provided services include at least one service of an image transmitting service, an image printing service, an image opening service on a network and an image storing service by a server.

5. A service system, comprising:
a communication device comprising:
a recording device which records images;
a display device which displays the images recorded on the recording device for a user and simultaneously displays a service menu indicating a plurality of services provided by a service center;
a selecting device through which the user selects a desired image for which the user desires a service from among the displayed images, and selects a desired service from the service menu; and
a communicating device which simultaneously transmits information showing the selected image and the selected service through a network; and
the service center comprising:
a recording device on which a service menu showing a plurality of services provided for the user;
a communicating device which transmits the service menu recorded on the recording device to a user side and simultaneously receives information showing the desired image and the desired service from the user side; and
a device which provides a service corresponding to the received information showing the desired image and the desired service.

6. A service method, comprising the steps of:
simultaneously displaying a service menu provided by a service center and recorded images by a communication device of a user side;
selecting an image for which the user desires a service from among the displayed images and selecting an image and a service desired by the user from the service menu; and
simultaneously transmitting information showing the selected image and service through a network.

7. A service method, comprising the steps of:
transmitting a service menu showing a plurality of services to be provided to a user which are previously recorded to a user side by a service center;
simultaneously displaying the received service menu and the recorded images by a communication device of the user side;
selecting an image for which the user desires a service from among the displayed images and an image and a service desired by the user from the service menu by the communication device of the user side;
simultaneously transmitting information showing the selected image and service through a network by the communication device of the user side; and
simultaneously receiving the information showing the image and the service from the user side and providing a service corresponding to the information showing the received image and service by the service center.

8. An image reading software having an image reading function for displaying, on a display device of a personal computer, images recorded on at least one of a recording device incorporated in at least one of the personal computer, an external recording device and an electronic camera connected to the personal computer, the software comprising:
a transmit image selecting function which selects at least one image from among the images displayed on the display device by the image reading function in accordance with an instruction and input of a pointing device in order to transmit the image to a desired home page on the internet;
a home page selecting function which displays buttons showing a plurality of home pages as destinations to which the at least one image is transmitted on the display device together with the at least one image and selects a desired home page in accordance with the instruction and input of the pointing device; and
a function which automatically transmits the at least one image and information attached to the at least one image to the selected home page when the at least one image is selected and the desired home page as the destination to which the at least one image is transmitted is selected.
